(19) United States
(12) Patent Application Publication
(10) Pub. No.: US 2010/0064233 A1
(43) Pub. Date: Mar. 11, 2010

(54) System, method, and apparatus for generating a portlet by merging content from a plurality of portlets

(76) Inventors: Ami H. Dewar, Durham, NC (US); Robert C. Leah, Cary, NC (US); Nicholas E. Poore, Durham, NC (US); Peter C. Yim, Raleigh, NC (US)

Correspondence Address: HOLMAN IP LAW/IBM RSW, 175 S Main Street, Suite #850, Salt Lake City, UT, 84111, US

(21) Appl. No.: 12/207,330

(22) Filed: Sep. 9, 2008

(51) Int. Cl. G06F 3/048; G06F 15/16

(52) U.S. Cl. 715/760; 709/202

(57) ABSTRACT

An apparatus, system, and method for generating an object for a portal platform from a plurality of objects. The system includes a content selection tool that selects uniform resource locator (URL) addressable content from a web source and further URL addressable content from a further web source. A platform specification tool selects a platform agnostic container comprising the URL addressable content and the further URL addressable content. A platform specific portal framework is indicated for the platform agnostic container. A content object for the indicated platform specific portal framework is generated, the content object containing the URL addressable content and the further URL addressable content. A portal customization tool customizes a portal in accordance with the platform specific portal framework. The content objects remain synchronized with a source of the URL addressable content and a further source of the further URL addressable content.

### BACKGROUND

Users of the Internet are typically interested in content from many disparate sources. As a result, portal sites have attained great popularity due to the ability to allow users to aggregate content, often called portals, from many different sources. A portal can include many different portlets each associated with a different uniform resource indicator (URI) addressable content source. A vast array of new technologies has given users more control in how they collect and consume content. These technologies have allowed users to create personalized pages, which are pages with aggregated data from many remote sources and/or portal sites.

Currently, user created portal pages rely on a catalog of customized objects specifically designed for the server which hosts the customized page. These catalogs are typically made up of content aggregating code snippets which are often called widgets or gadgets. Each widget or gadget is specific to the content it is created to aggregate and is specific to the portal server platform. For example, gadgets available for iGoogle.com conform to an iGoogle API and are unable to be used by other portal sites. Similarly, widgets available from Yahoo.com are not compatible with other portal sites. Currently, there is no industry standard for widgets, portal sites or user created portal pages.

### SUMMARY

Embodiments of a system are described. In one embodiment, the system operates to generate an object for a portal platform from a plurality of objects. In certain embodiments, the system includes a content selection tool accessible via a web interface from a remotely located client. The content selection tool selects a uniform resource locator (URL) addressable content from a web source and a further URL addressable content from a further web source.

Embodiments of the system also include a platform specification tool accessible via a web interface from the remotely located client. The platform specification tool selects a platform agnostic container comprising the URL addressable content and the further URL addressable content established by the content selection tool. In some embodiments, a platform specific portal framework is indicated for the selected platform agnostic container. Use of the platform specification tool generates a content object for the indicated platform specific portal framework, the content object containing the URL addressable content and the further URL addressable content.

In some embodiments, the system also includes a portal customization tool accessible via a web interface from the remotely located client for customizing a portal in accordance with the platform specific portal framework. Customization may be carried out using a set of selectable software objects which can be placed within a customized portal. In some embodiments, the set of selectable software objects comprises content objects generated using the platform specification tool. The content objects remain synchronized with a source of the URL addressable content and a further source of the further URL addressable content in some embodiments. Other embodiments of the system are also described.

Embodiments of a method are also described. In one embodiment, the method is a method for generating an object for a portal platform from a plurality of objects. One embodiment of the method includes selecting a uniform resource locator (URL) addressable content from a web source and a further URL addressable content from a further web source. The method may also include establishing a platform agnostic container for the URL addressable content and the further URL addressable content. The platform agnostic container comprises a link to the URL addressable content and a further link to the further URL addressable content in some embodiments.

In one embodiment, the method includes adjusting the platform agnostic container for the portal platform. The method may also include adding the adjusted platform agnostic container to a set of user selectable objects for the portal platform. The user selectable objects may be customizable by a user to create a customized portal for the portal platform accessible via a URL associated with the portal platform. The URL addressable content and the further URL adjustable content appear with the customized portal in response to selection of the adjusted container in certain embodiments. Other embodiments of the method are also described.

Embodiments of a computer program product are also described. The computer program product, in one embodiment, includes operations to manage a platform agnostic container for generating an object for a portal platform from a plurality of objects. In one embodiment, the platform agnostic container includes a platform agnostic region within which a uniform resource locator (URL) addressable content and a further URL addressable content are placed.

In certain embodiments, the computer program product includes operations to operate a plurality of platform specific interfaces each configured to permit the platform agnostic container to interact with a platform specific application program interface (API). The platform specific API may be an interface for establishing a platform specific object from the platform agnostic container. In some embodiments, the platform specific object remains synchronized with the URL addressable content and the further URL addressable content. Other embodiments of the computer program product are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE SEVERAL VIEWS OF THE DRAWINGS

FIG. 1 depicts a schematic diagram of one embodiment of a system for containers of uniform resource locator (URL) addressable content which can generate objects for use on one or more portal platforms using a plurality of URL addressable content sources.

FIG. 2 depicts a schematic diagram of one embodiment of a system for selecting portlet content and placing the portlet content into objects of a portal platform using platform agnostic containers.

FIG. 3 depicts a schematic diagram of one embodiment of a graphical user interface (GUI) for using platform agnostic containers.

FIG. 4 depicts a schematic diagram of one embodiment of a system for manipulating URL addressable content for use with a portal platform.

FIG. 5 depicts a schematic diagram of one embodiment of a system for combining content from a plurality of URL addressable sources using a template.

FIG. 6 depicts a flow chart diagram of one embodiment of a method for using a platform agnostic container to generate an object for use on a portal platform.

FIG. 7 depicts a flow chart diagram of one embodiment of a method for combining content from a plurality of sources using a template.

FIG. 8 depicts a flow chart diagram of one embodiment of a method for combining content based on a commonality between the content.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments export content for syndication on a portal platform. In general, many of the embodiments described involve combining content from two or more content sources into a single content object for use with a portal platform.

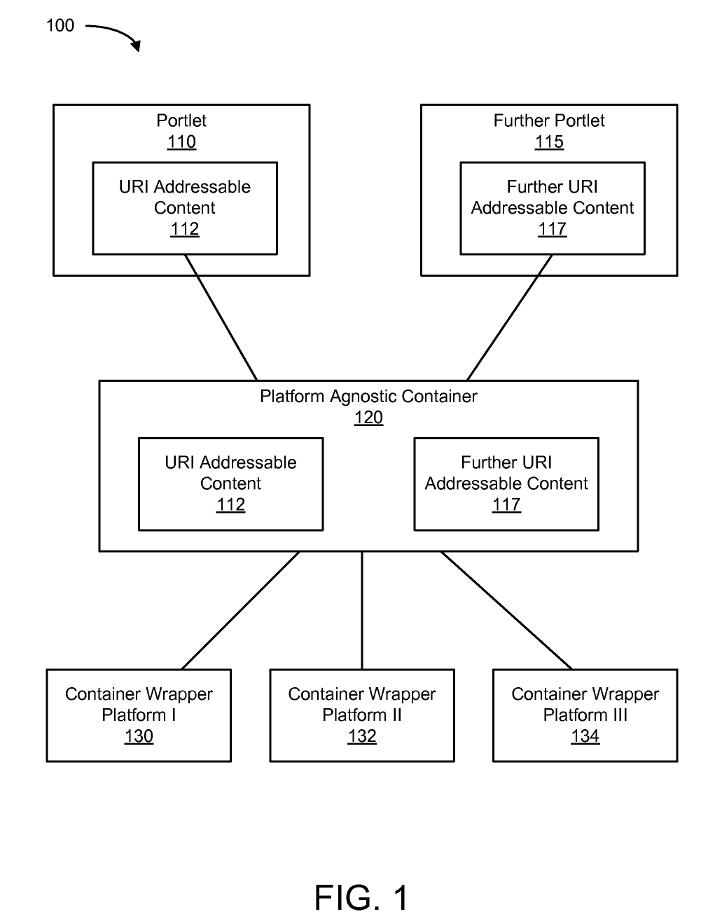

FIG. 1 is a schematic diagram illustrating a system 100 for containers of user selected URL addressable content, which can generate platform specific software objects for a platform specific, user customizable portal page. In system 100, a URI addressable content 112 and a further URI addressable content 117 can be encapsulated/placed in a platform agnostic container 120. The platform agnostic container 120 enables the content 112, 117 to be encapsulated in a platform independent manner.

The URI addressable content 112 and the further URI addressable content 117 may comprise any type of URI addressable content. For example, the URI addressable content 112 may be accessible as a component of a portlet 110, 115. In another example, the further URI addressable content 117 may be extractable from a gadget for an iGoogle™ personalized portal. In yet another example, the URI addressable content 112 may be extractable from a widget for My Yahoo!™ In certain embodiments, the URI addressable content 112 and/or the further URI addressable content 117 may comprise uniform resource locator (URL) addressable content.

The platform agnostic container 120 may be software wrapped in a platform specific wrapper 130-134 enabling interoperability with a target portal platform or framework. Alternatively, a set of programmatically defined conversions may transform the platform agnostic container 120 into a platform specific software object 130-134. The software objects 130-134 may remain synchronized to the source of the URI addressable content 112 and the further URI addressable content 117, which ensures information currency. Programmatic instructions specific to the platform agnostic container 120 may ensure content synchronization.

Each of the software objects 130-134 may be treated as “widgets” or “gadgets” which a user can select and add to a customized portal page associated with the platform framework of the software object 130-134. Effectively, the containers 120 function as a layer of abstraction that permits user selected URI addressable content 112 to be placed in a customized portal (as a software object 130-134) in an automatically updated manner. Platform agnostic containers 120, therefore, permit a combination of elements from a portlet 110 and a further portlet 115 to be “syndicated” to a portal platform as a single content object.

The portlet 110 may represent any selectable URI addressable content including, but not limited to, portlets, web pages, embedded content, and the like. The platform agnostic container 120 can include technologies such as AJAX, WSRP, JSR168, and the like. The software objects 130-134 can be customized for any number of portal frameworks, such as Google's portal framework, Netvibes' portal framework, Yahoo's portal framework, and the like.

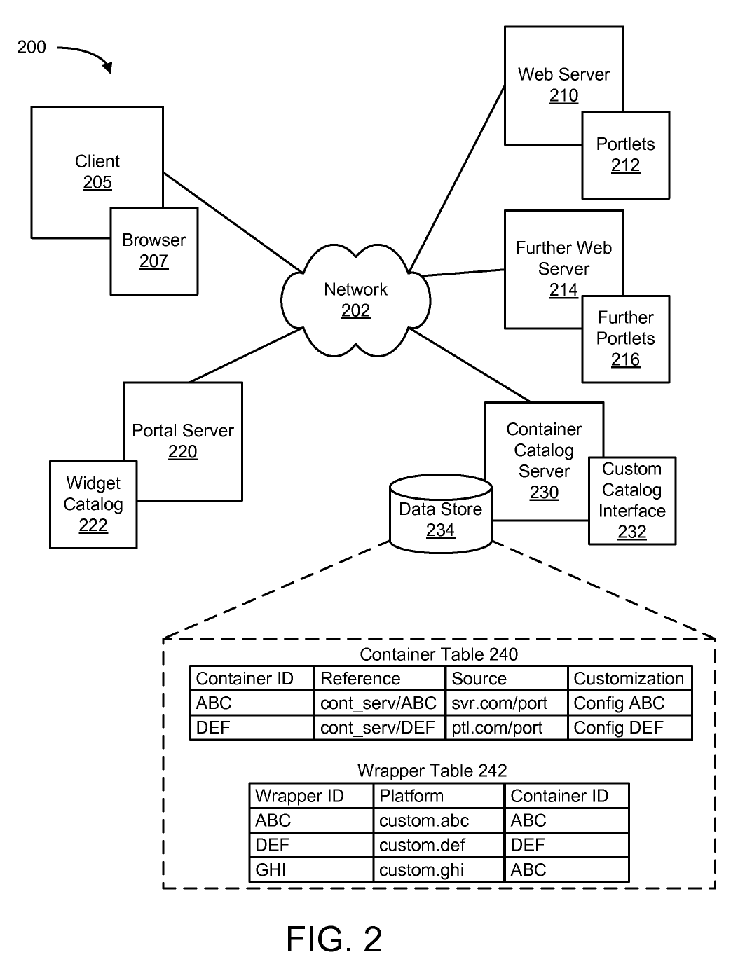

FIG. 2 is a schematic diagram illustrating a system 200 for combining portlet 212 content and further portlet 216 content and placing the combined content in widgets 222 of a portal server 220 via platform agnostic containers.

In system 200, a container catalog server 230 may allow combinations of content from one or more portlets 212 on web server 210 and content from one or more further portlets 216 on the further web server 214 to be interoperable with an external portal server 220. The container catalog server 230 may present a user with a custom catalog interface 232 which allows a user to add any portlet 212 content combined with any further portlet 216 content to a platform specific portal server 220.

The container catalog server 230, in one embodiment, provides a platform agnostic container and platform specific wrapper for content from a portlet 212 and content from a further portlet 216. The container and wrapper configuration can be directed by data stored in data store 234. Customization of the container may be performed through a custom catalog interface 232. The container table 240, in one embodiment, stores container ID, source content, customization settings, and the like. Specific wrapper level settings may be stored in a wrapper table 242. The wrapper table 242 may denote wrapper ID, the platform targeted by the wrapper, the container associated with the wrapper, and the like.

A client 205 utilizing a Web browser 207, in certain embodiments, includes a plug-in for interacting with a custom catalog interface 232. In one embodiment, the custom catalog interface 232 is a searchable compilation presented to a user in a desktop application.

To illustrate components of system 200, the browser 207 may include a container plug-in, which permits a user to present portlet 212 content and to send a reference to the portlet 212 to the container catalog server 230. This causes a new entry of the container table 240 to be established for a new container (e.g., Container ABC). This entry may include a reference link (e.g., http://cont_serv.com/ABC) and may include a reference to the source (e.g., http://svr.com/port). Other portlets 212, 216 may be browsed 207 and targeted for the container catalog server 230, which results in additional container table 240 entries (e.g., Container DEF). The client 205 can then access the container catalog server 230 via the custom catalog interface 232. In a further example, a container may include reference links to a plurality of sources representing content from a plurality of portlets.

The custom catalog interface 232 may present the user with the user created containers as well as other containers that the user is authorized to access. In one embodiment, users may be permitted to share their containers with other users and a set of common use containers may also be established by the container catalog server 230. A user can choose to customize a container, which adds a customization entry to the container table 240. Using the custom catalog interface 232, the user of the client 205 may select a target portal platform. Upon selection, a new software object (e.g., a widget in a widget catalog 222) for the target portal platform may be generated.

Each container can be used to generate multiple software objects for different portal platforms. Each software object can be associated with an entry in the wrapper table 242. That is, a wrapper (e.g., ABC) for platform (e.g., custom.abc) can be associated with a container (Container ABC). In a different implementation (that transforms instead of wraps containers), the wrapper table 242 can indicate transformation programs to be executed to convert a particular container into a software object conforming to a target portal platform.

After a software object has been created from a container, the client 205 can access a widget catalog 222 of the portal server 220, which includes container generated objects. The widget catalog 222 can be an optional component available on some, but not all, portal platforms. When no widget catalog 222 exists for a target platform, the software object created from the container can be placed in a user-accessible data store (e.g., a data store of client 205, a data store of the portal server 220, etc.). The client 205 can add the container objects and other widgets to create a custom portal page. When a custom portal is presented in browser 207 that includes a server 230 generate software object, the object can remain synchronized with the portlet 212 and the further portlet 216 to ensure information currency.

The data store 234 may be physically implemented within any type of hardware including, but not limited to, a magnetic disk, an optical disk, a semiconductor memory, a digitally encoded plastic memory, a holographic memory, or any other recording medium. The data store 234 may be stand-alone storage units as well as a storage unit formed from a plurality of physical devices, which may be remotely located from one another. Additionally, information may be stored within the data store 234 in a variety of manners. For example, information, such as tables 240, 242, can be stored within a database structure or can be stored within one or more files of a file storage system, where each file may or may not be indexed for information searching purposes.

The network 202, in certain embodiments, includes components capable of conveying digital content encoded within carrier waves. The content may be contained within analog or digital signals and conveyed through data or voice channels and can be conveyed over a personal area network (PAN) or a wide area network (WAN). The network 202 may include local components and data pathways necessary for communications to be exchanged among computing device components and between integrated device components and peripheral devices. The network 202 may also include network equipment, such as routers, data lines, hubs, and intermediary servers which together form a packet-based network, such as the Internet or an intranet. The network 202, in one embodiment, includes circuit-based communication components and mobile communication components, such as telephony switches, modems, cellular communication towers, and the like. The network 202 may include line based and/or wireless communication pathways.

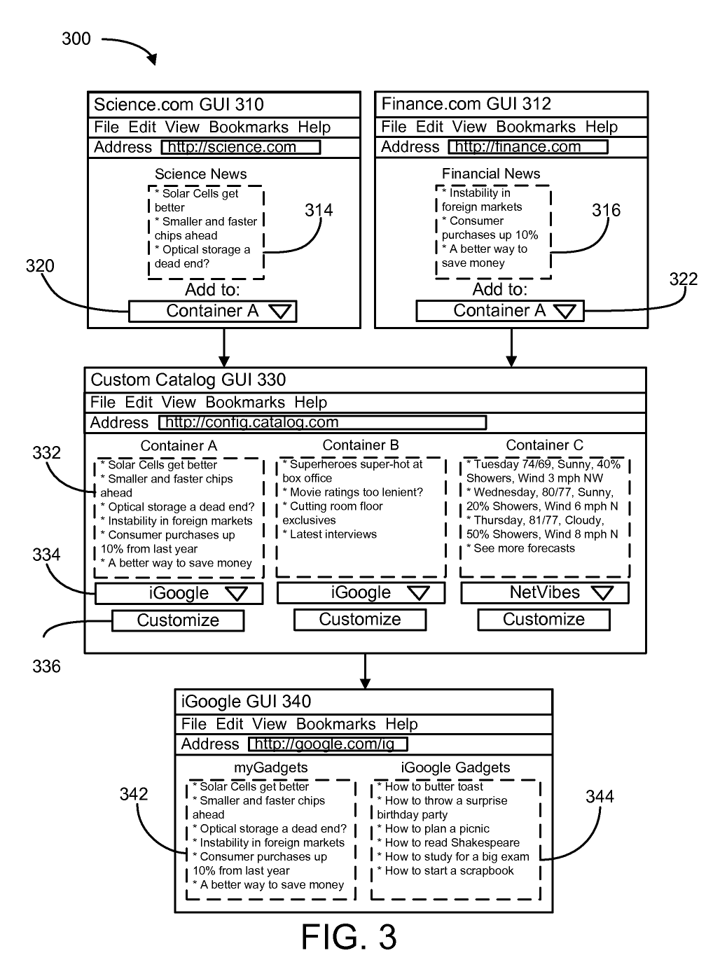

FIG. 3 depicts a graphical user interface (GUI) illustrating a system 300 for using platform agnostic containers. GUIs of the system 300 may be interfaces of the system 200 described in relation to FIG. 2.

In one embodiment of the system 300, a user can access a science Web page shown in GUI 310. This Web page can include a section 314 of URL addressable content. An export control 320 can permit the section 314 to be exported to a user selectable container (e.g., Container A). The user can also access a finance Web page as shown in GUI 312. GUI 312 can include a new portlet section 316, which a user can select and export to Container A using control 322. The controls 320, 322 can be coded specifically for the Web sites, can be browser controls, and/or can be associated with a browser plug-in designed to export content to containers when enabled. In another embodiment, (not shown) a container specific Web page can include the controls 320, 322 and can include an interior browsing frame section, which enables a user to navigate to desired content and subsequently select portions of that content (314, 316).

After sending content to containers, a user can access a custom catalog GUI 330. The custom catalog GUI 330 can include containers for user available content, options to convert a container to a target portal platform 334, and options to customize 336 the containers. Containers need not be identical to an original source, as shown by section 332, which combines content from section 314 and section 316.

After one or more containers have been transformed for a target platform, a user can access an interface 340 for that platform. The container created software object 342 may be selectable along with other software objects 344 specifically designed for the portal platform.

It should be appreciated that the graphical user interface (GUI), GUI elements, and graphical artifacts presented herein are for illustrative purposes only and are not meant to limit the invention in any regard.

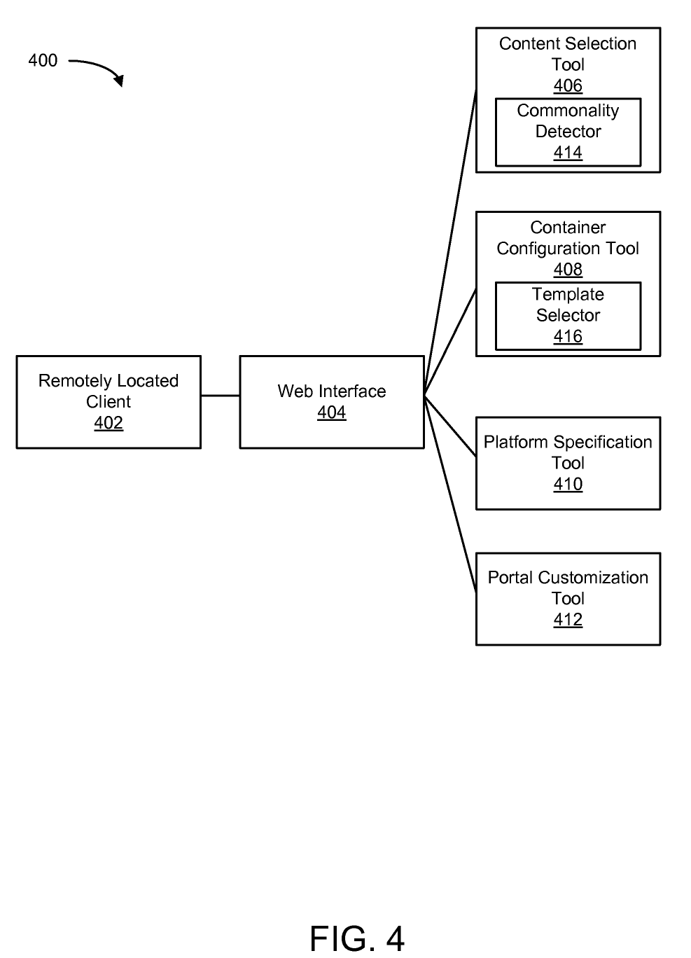

FIG. 4 depicts a schematic diagram of one embodiment of a system 400 for manipulating URL addressable content for use with a portal platform. The system 400 includes a remotely located client 402, a Web interface 404, a content selection tool 406, a container configuration tool 408, a platform specification tool 410, and a portal customization tool 412. The system 400 selects URL addressable content and further URL addressable content for combination and use with the portal platform.

The remotely located client 402, in one embodiment, provides access for a user to operate the system 400 to select and publish content to a portal platform. The remotely located client 402 may be any type of client capable of interacting with the system 400. For example, the remotely located client 402 may comprise a personal computer connected to the Internet and operating a web browser.

The web interface 404 provides an interface for Web access to the system 400 in certain embodiments. The web interface 404 may be accessed by the remotely located client 402. In some embodiments, the web interface 404 interacts with other elements of the system 400 to direct those elements of the system 400 to operate in response to input from the remotely located client 402.

The content selection tool 406 selects content to be added to a container and exported for a portal platform. In one embodiment, the content selection tool 406 selects content in response to inputs from a user. In alternate embodiment, the content selection tool 406 selects content in response to automated processes.

For example, the content selection tool 406 may poll a collection of remotely created and stored content and search for elements of the content that causes the content selection tool 406 to select the content for export. The content selection tool 406 may search metadata associated with the content or tags associated with the content. In another example, the content selection tool 406 may access a database that includes information associated with the content.

In one embodiment, the content selection tool 406 includes a commonality detector 414. The commonality detector 414 analyzes information associated with a URL addressable content and compares that information to further information associated with a further URL addressable content. If the comparison determines that a commonality exists between the URL addressable content and the further URL addressable content, the commonality detector 414 may indicate that a commonality exists. In response to a determination that a commonality exists, the content selection tool 406 may select the URL addressable content and the further URL addressable content for combination into a container.

For example, the URL addressable content may comprise scores from a particular sporting event and include a tag that identifies the sporting event. The further URL addressable content may comprise video from the same sporting event and have a database entry that indicates that the video is from that sporting event. The commonality detector 414 may compare the tag to the database entry and determine a commonality exists between the URL addressable content and the further URL addressable content since both pieces of content pertain to the same sporting event. The content selection tool 406 may select the URL addressable content and the further URL addressable content for combination in a container in response to the determination that a commonality exists.

The container configuration tool 408, in one embodiment, configures the platform agnostic container. In certain embodiments, the container configuration tool 408 modifies the platform agnostic container to accommodate the selected type or types of content selected by the content selection tool 406. For example, the content selection tool 406 may select video content from one web source and text content from another web source. In this example, the container configuration tool 408 may modify the platform agnostic container to accommodate both video and text content.

In one embodiment, the container configuration tool 408 includes a template selector 416. The template selector 416 selects a template from a catalog of templates (not shown) appropriate for the selected content. In the above example, where the content comprises video from one source and text from another source, the template selector 416 may select a template that accommodates video and text.

In certain embodiments, the template selected by the template selector 416 may indicate a size and relative position for display of selected content. In the above example, the template selected by the template selector 416 may include a window for displaying video of a particular size located above a text box for displaying text content.

In some embodiments, the container configuration tool 408 configures the platform agnostic container in response to an input from the remotely located client 402. For example, a user operating the remotely located client 402 may select a particular template for use with the selected content.

In an alternate embodiment, the container configuration tool 408 configures the platform agnostic container in response to the selected content without input from a user. For example, when video content and text content are selected, the container configuration tool 408 may direct the template selector 416 to select a particular template that accommodates video and text content.

In yet another embodiment, the container configuration tool 408 selects a set of templates appropriate for the selected content and presents the set through the web interface 404 to the remotely located client 402. The user may then select a template from among the set of templates to configure the platform agnostic container.

The platform specification tool 410, in one embodiment, specifies a particular portal framework for use with the platform agnostic container. The platform specification tool 410 may generate a content object from the platform agnostic container capable of operating on the particular portal framework. For example, the portal framework may be an iGoogle™ portal page, and the platform specification tool 410 may generate a gadget that operates on the iGoogle™ portal page.

In certain embodiments, the platform specification tool 410 specifies a portal framework in response to an input from a user at the remotely located client 402. In an alternate embodiment, the platform specification tool 410 specifies a portal framework without input from a user. For example, the platform specification tool 410 may automatically generate an object for a Netvibes™ page in response to detecting a container containing content.

The portal customization tool 412, in one embodiment, customizes a portal in accordance with the particular portal framework using a set of selectable software objects. The portal customization tool 412 may operate in response to input from a user at remotely located client 402. In certain embodiments, the portal customization tool 402 operates automatically. In one embodiment, the portal customization tool 412 presents one or more content objects created by the system 400 and allows the user at the remotely located client 402 to control the presence and location of the one or more content objects on a portal page.

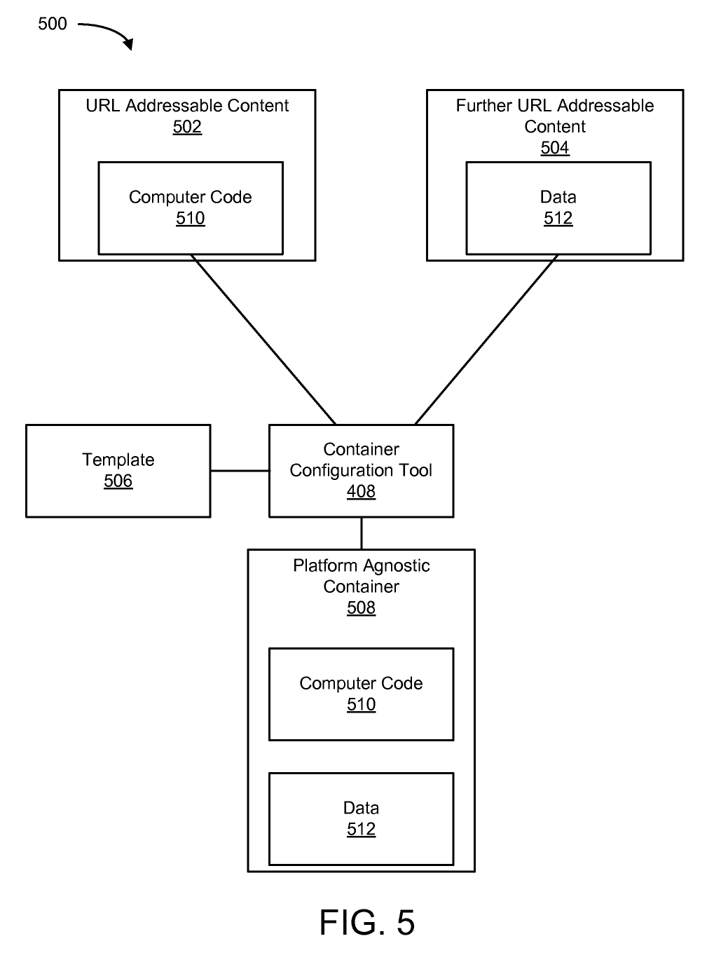

FIG. 5 depicts a schematic diagram of one embodiment of a system 500 for combining content from a plurality of URL addressable sources using a template 506. The system 500 includes URL addressable content 502, further URL addressable content 504, a container configuration tool 408, a template 506, and a platform agnostic container 508. The system 500 configures the platform agnostic container 508 to contain content from two or more sources.

The URL addressable content 502, in one embodiment, comprises some type of exportable content capable of being repackaged in an object for a portal site. The further URL addressable content 504 may similarly comprise any type of exportable content.

Examples of URL addressable content 502 include a news feed, content from a portlet, and content scraped from a webpage. For example, the URL addressable content 502 may be a portlet that comprises computer code 510 that causes a computer to perform operations when the code is executed on a computer.

Examples of such computer code include video content, interactive game content, and input gadgets.

Another example of URL addressable content 502 is data 512. Data may comprise any type of content other than computer code 510. For example, data 512 may comprise text, such as a news story, a blog post, sporting event scores, stock quotes, or other data.

The container configuration tool 408 may be configured in a similar manner to the same numbered element described in relation to FIG. 4. The container configuration tool configures the platform agnostic container 508 to contain the URL addressable content 502 and the further URL addressable content 504. In the illustrated embodiment, the container configuration tool 408 configures the platform agnostic container 508 to contain content from two sources. In another embodiment, the container configuration tool 408 configures the platform agnostic container 508 to contain content from any number of sources.

In some embodiments, the container configuration tool 408 uses a template 506 to configure the platform agnostic container 508. The template 506, in one embodiment, directs the container configuration tool 408 to configure the platform agnostic container 508 to contain and arrange the content in a particular manner. For example, the platform agnostic container 508 may be configured to contain computer code 510 and data 512. The template 506, in this example, may direct the platform agnostic container 508 to position the computer code 510 above the data 512. This template 506 may be useful in configuring a platform agnostic container 508 when content from computer code 510 and data 512 are related to the same topic, such as the example described previously where the computer code 510 plays video from a sporting event and the data 512 include scores for the same sporting event.

The platform agnostic container 508, in one embodiment, contains content from a plurality of sources. The platform agnostic container 508 may be configured to communicate with the original sources such that the content stored in the platform agnostic container 508 is periodically or continually updated. In an alternate embodiment, the platform agnostic container 508 contains links to a plurality of sources.

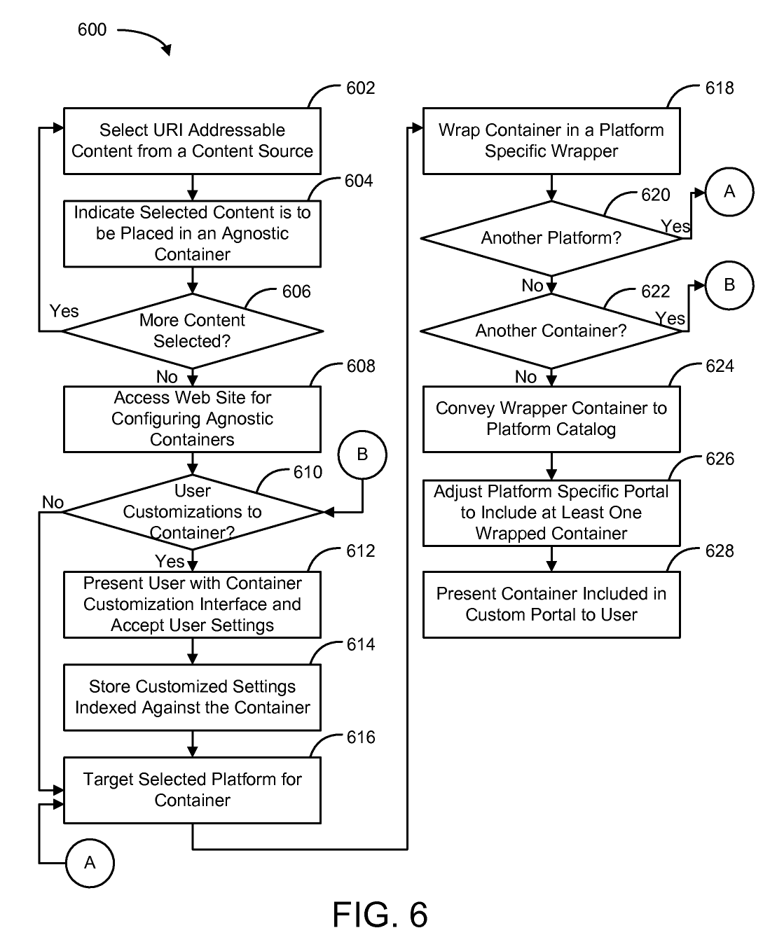

FIGS. 6-8 are flowcharts illustrating methods 600, 700, 800 for use of platform agnostic containers. The methods 600, 700, 800 are, in certain embodiments, methods of use of the systems and apparatuses of FIGS. 1-5, and are described with reference to those figures. Nevertheless, the methods 600, 700, 800 may also be conducted independently thereof and are not intended to be limited to the specific embodiments discussed above with respect to those figures.

In method 600, URI addressable content is selected to be exported to a target portal site. As shown in FIG. 6, the content selection tool 406 selects 602 URI addressable content (e.g., portlet content) from a content source. The selection 602 may be in response to input from a user. In another embodiment, selection 602 is in response to an automatic process, such as a determination of commonality between content from two or more content sources.

The content selection tool 406 may also indicate 604 that the selected content is to be placed in a platform agnostic container 508. This indication 604 may be in response to a user input or an automatic process.

The content selection tool 406, in one embodiment, determines 606 whether more content is to be selected. If more content is selected, the method 600 returns to step 602. Otherwise, the method 600 can proceed to step 608. Any number of items of content from any number of content sources may be selected 602.

The container configuration tool 408 accesses 608 a Web site for configuring the platform agnostic container 508 in one embodiment. The container configuration tool 408 may receive an input from a user through the Web to determine how to configure the platform agnostic container 508.

In alternate embodiment, the container configuration tool 408 accesses a template catalog to retrieve a template 506. The template 506 may direct the container configuration tool 408 and define how the platform agnostic container 508 is to be configured.

In certain embodiments, the container configuration tool 408 determines 610 if the user has customizations to the platform agnostic container 508. If the container configuration tool 408 determines 610 that there are customizations, the method proceeds to step 612. Otherwise, the method proceeds to step 616.

The container configuration tool 408, in one embodiment, presents 612 the user with the container customization interface. In certain embodiments, the container configuration tool 408 receives and accepts user settings relating to the container customization interface. For example, the user may be presented with a container customization interface within which user settings may be established and finalized. In some embodiments, the container configuration tool 408 stores 614 and indexes the customized settings against the container.

The container configuration tool 408, in one embodiment, targets 616 a selected platform for the platform agnostic container 508. The platform may be targeted 616 in response to an input from a user. For example, the user may select the My Yahoo!™ platform. In an alternate embodiment, the platform is targeted 616 in response to an automatic process. For example, the container configuration tool 408 may indicate that all platform agnostic containers 508 should be targeted 616 for the iGoogle™ platform.

The container configuration tool 408, in some embodiments, wraps 618 the platform agnostic container 508 in a platform specific wrapper to make it interoperable with the target platform. In a different embodiment, the platform agnostic container 508 is converted into a platform specific software object.

In some embodiments, the container configuration tool 408 determines 620 if another platform is selected. In response to the selection of another platform, the method 600 may proceed to step 616. Otherwise, the method 600 can proceed to step 622.

The container configuration tool 610, in certain embodiments, determines 622 if another container is selected. In response to the selection of another container, the method 600 may return to step 610. Otherwise, the method 600 may proceed to step 624.

The portal customization tool 412, in one embodiment, conveys 624 the wrapper container to a platform catalog. In certain embodiments, the portal customization tool 412 adjusts 626 the platform specific portal to include one or more wrapped containers. For example, a wrapped container may be selected and added to a customized portal.

In some embodiments, and the portal server 220 presents 628 the wrapped container in a custom portal. Content of the container can remain synchronized with the original source and can be updated accordingly.

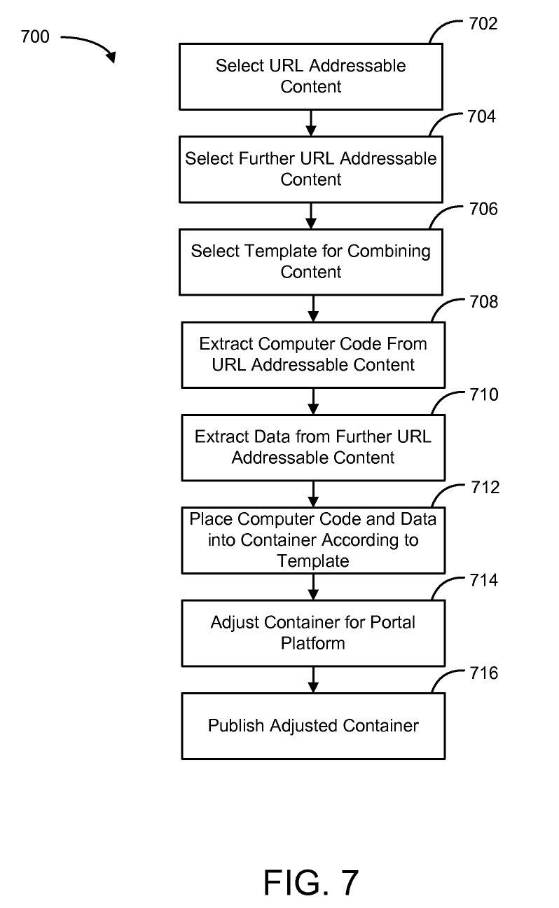

In method 700, content from a plurality of sources is combined into a single platform agnostic container 508 using a template 506. As shown in FIG. 7, the content selection tool 406 selects 702 URL addressable content. Selection 702 of URL addressable content may be in response to a user input. In an alternate embodiment, selection 702 of URL addressable content may be conducted automatically. For example, the content selection tool 406 may select 702 an item of URL addressable content in response to an update in a news feed.

In certain embodiments, the content selection tool 406 selects 704 further URL addressable content. Selection 704 of further URL addressable content may be in response to user input. In an alternate embodiment, selection 704 of further URL addressable content may be conducted automatically. For example, the content selection tool 406 may select 704 further URL addressable content in response to a commonality between the further URL addressable content and the URL addressable content.

The container configuration tool 408, in one embodiment, selects 706 a template 506 for combining the URL addressable content with the further URL addressable content. In some embodiments, selection 706 of a template 506 is in response to user input. In an alternate embodiment, selection 706 a template 506 is in response to a determination based on the type of content selected.

The container configuration tool 408 extracts 708 computer code 510 from the URL addressable content in one embodiment. In some embodiments, the container configuration tool 408 extracts 710 data 512 from the further URL addressable content. The container configuration tool 408 places 712 the computer code of 510 and a data 512 into the platform agnostic container 508 according to the template 506.

In alternate embodiments, the container configuration tool 408 may extract any combination of computer code 510 and data 512 from any type of URL addressable content. For example, the container configuration tool 408 may extract computer code from both the URL addressable content and the further URL addressable content. The extracted content may then be placed into the platform agnostic container 508 according to a template 506.

In some embodiments, the portal customization tool 412 adjusts 714 the platform agnostic container 508 for a portal platform. Adjusting 714 the platform agnostic container 508 may comprise generating a new object that matches the data requirements of the portal platform. In an alternate embodiment, adjusting 714 the container for a portal platform may comprise wrapping the platform agnostic container 508 with a wrapper.

In certain embodiments, the adjusted container is published 716. Publication 716 of the adjusted container may comprise adding the adjusted container to a catalog at the portal server. In an alternate embodiment, publication 716 of the adjusted container may comprise adding the adjusted container to a news feed.

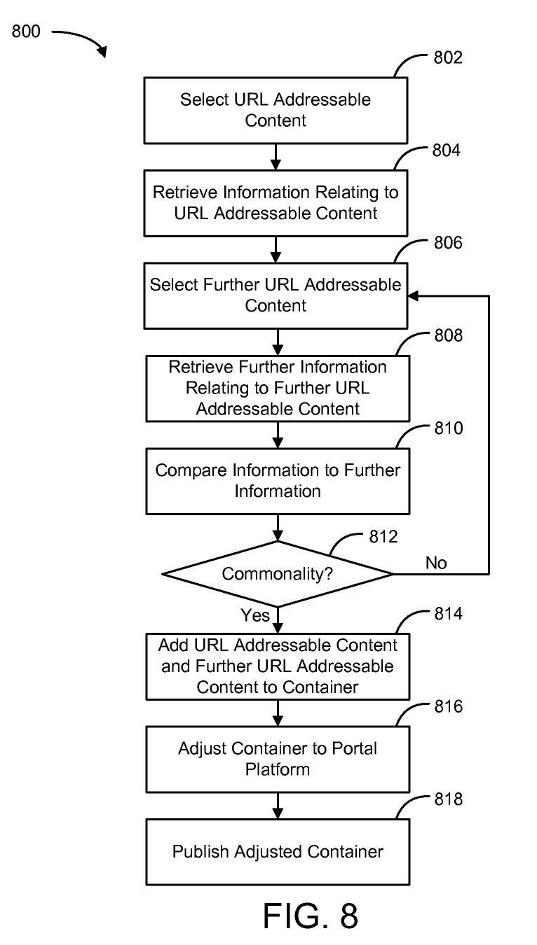

In method 800, content from a plurality of sources is combined into a single platform agnostic container 508 based on a commonality between the content. As shown in FIG. 8, the content selection tool 406 selects 802 URL addressable content. Selection 802 of URL addressable content may be in response to a user input. In an alternate embodiment, selection 802 of URL addressable content may be conducted automatically. For example, the content selection tool 406 may select 802 an item of URL addressable content in response to an update in a news feed.

The content selection tool 406, in some embodiments, retrieves 804 information relating to the URL addressable content. The information may include any type of information associated with the URL addressable content. For example, the information may be a meta tag, a database entry, information determined by the source of the URL addressable content, or another type of information.

In one embodiment, the content selection tool 406 selects 806 further URL addressable content for comparison to the URL addressable content. Selection 806 of the further URL addressable content may be in response to an algorithm. For example, the content selection tool 406 may select a piece of content that has not previously been compared to the URL addressable content and is from the same type of source.

The content selection tool 406, in one embodiment, retrieves 808 further information relating to the further URL addressable content. The information may include any type of information associated with the further URL addressable content. For example, the information may be a meta tag, a database entry, information determined by the source of the further URL addressable content, or another type of information.

In certain embodiments, the content selection tool 406 compares 810 the information to the further information to determine 812 if a commonality exists between the URL addressable content and the further URL addressable content. If no commonality exists, the content selection tool 406 may return to select 806 a different further URL addressable content.

If the content selection tool 406 determines 812 that a commonality does exist, the container configuration tool 408 may add 814 the URL addressable content and the further URL addressable content to a platform agnostic container 508. The container configuration tool 408 may adjust 816 the container to the requirements of a selected portal platform and publish 818 the adjusted container.

The various embodiments described herein allow the combination of content from two or more URL addressable content sources into a single platform agnostic container which may be adjusted for use on a specified portal platform.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations to select a uniform resource locator (URL) addressable content from a web source and a further URL addressable content from a further web source. In one embodiment, the operations include an operation to establish a platform agnostic container wherein a content of the platform agnostic container comprises the URL addressable content and the further URL addressable content. The platform agnostic container may be adjusted for the portal platform by the computer program product. In certain embodiments, the operations include adding the adjusted platform agnostic container to a set of user selectable objects for the portal platform, wherein the user selectable objects are customizable by a user to create a customized portal for the portal platform accessible via a URL associated with the portal platform, wherein the URL addressable content and the further URL addressable content appear with the customized portal in response to selection of the adjusted container. Other embodiments of the computer program product may implement fewer or more instructions according to the functionality described herein.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product for generating an object for a portal platform from a plurality of objects, the computer program product comprising a computer useable storage medium to store a computer readable program, wherein the computer readable program, when executed on a computer, causes the computer to perform operations comprising:
selecting a uniform resource locator (URL) addressable content from a web source and a further URL addressable content from a further web source;
establishing a platform agnostic container wherein a content of the platform agnostic container comprises the URL addressable content and the further URL addressable content;
adjusting the platform agnostic container for the portal platform; and
adding the adjusted platform agnostic container to a set of user selectable objects for the portal platform, wherein the user selectable objects are customizable by a user to create a customized portal for the portal platform accessible via a URL associated with the portal platform, wherein the URL addressable content and the further URL addressable content appear with the customized portal in response to selection of the adjusted container.

2. The computer program product of claim 1, wherein the URL addressable content comprises computer code that causes a computer to perform operations when executed on the computer.

3. The computer program product of claim 1, wherein the computer readable program, when executed on the computer, causes the computer to perform an operation to select the URL addressable content and the further URL addressable content in response to a commonality of content between the URL addressable content and the further URL addressable content.

4. The computer program product of claim 3, wherein the commonality of content is determined by comparing a tag associated with the URL addressable content to a tag associated with the further URL addressable content.

5. The computer program product of claim 3, wherein the commonality of content is determined by:
retrieving information relating to the URL addressable content from a database;
retrieving further information relating to the further URL addressable content from a database; and
comparing the information to the further information.

6. The computer program product of claim 1, wherein the selection of the URL addressable content is in response to an input from the user.

7. The computer program product of claim 1, wherein the computer readable program, when executed on the computer, causes the computer to perform an operation to synchronize a content of the adjusted container with the web source and the further web source.

8. A system for generating an object for a portal platform from a plurality of objects, the system comprising:
a content selection tool accessible via a web interface from a remotely located client for selecting a uniform resource locator (URL) addressable content from a web source and a further URL addressable content from a further web source;
a platform specification tool accessible via a web interface from the remotely located client for selecting a platform agnostic container comprising the URL addressable content and the further URL addressable content established by the content selection tool, wherein a platform specific portal framework is indicated for the selected platform agnostic container, wherein use of the platform specification tool generates a content object for the indicated platform specific portal framework, the content object containing the URL addressable content and the further URL addressable content; and
a portal customization tool accessible via a web interface from the remotely located client for customizing a portal in accordance with the platform specific portal framework using a set of selectable software objects which can be placed within the customized portal, wherein the set of selectable software objects comprises content objects generated using the platform specification tool, wherein the content objects remain synchronized with a source of the URL addressable content and a further source of the further URL addressable content.

9. The system of claim 8, wherein the URL addressable content and the further URL addressable content are located at separate websites maintained by separate entities.

10. The system of claim 8, further comprising a container configuration tool accessible via a web interface from the remotely located client, the container configuration tool configured to permit the user to customize the platform agnostic container.

11. The system of claim 10, wherein the container configuration tool is further configured to permit the user to customize the platform agnostic container to contain:
computer code from the URL addressable content that causes a computer to perform operations when executed on the computer; and
data from the further URL addressable content.

12. A method for generating an object for a portal platform from a plurality of objects, the method comprising:
selecting a uniform resource locator (URL) addressable content from a web source and a further URL addressable content from a further web source;
establishing a platform agnostic container for the URL addressable content and the further URL addressable content wherein the platform agnostic container comprises a link to the URL addressable content and a further link to the further URL addressable content;
adjusting the platform agnostic container for the portal platform; and
adding the adjusted platform agnostic container to a set of user selectable objects for the portal platform, wherein the user selectable objects are customizable by a user to create a customized portal for the portal platform accessible via a URL associated with the portal platform, wherein the URL addressable content and the further URL adjustable content appear with the customized portal in response to selection of the adjusted container.

13. The method of claim 12, wherein the platform agnostic container comprises a template for combining the URL addressable content with the further URL addressable content.

14. The method of claim 13, wherein the template comprises an extensible markup language (XML) schema.

15. The method of claim 13, wherein the template is configured to combine one type of content with another type of content.

16. The method of claim 13, wherein the template is configured to combine data content with computer code content.

17. The method of claim 13, wherein the template is provided by the user.

18. The method of claim 13, wherein the template is selected from a catalog of templates by the user.

19. A computer program product for managing a platform agnostic container for generating an object for a portal platform from a plurality of objects, the computer program product comprising a computer useable storage medium to store a computer readable program, wherein the computer readable program, when executed on a computer, causes the computer to perform operations comprising:
defining a platform agnostic region of the platform agnostic container within which a uniform resource locator (URL) addressable content and a further URL addressable content are placed; and
operating a plurality of platform specific interfaces each configured to permit the platform agnostic container to interact with a platform specific application program interface (API), wherein the platform specific API is an interface for establishing a platform specific object from the platform agnostic container, wherein the platform specific object remains synchronized with the URL addressable content and the further URL addressable content.

20. The computer program product of claim 19, wherein the operations further comprise managing a plurality of platform agnostic containers in a catalog of platform agnostic containers, each of the plurality of platform agnostic containers configured to be exportable in a platform specific format for use on the portal platform.
